(19) United States
(12) Patent Application Publication
(10) Pub. No.: US 2004/0064399 A1
(43) Pub. Date: Apr. 1, 2004

(54) Multi-variable computer-based auctions

(76) Inventors: Steven Phillip Gologorsky, Montville, NJ (US); Brian David Parlato, Hillsborough, NJ (US)

Correspondence Address: DEMONT & BREYER, LLC, SUITE 250, 100 COMMONS WAY, HOLMDEL, NJ, 07733, US

(21) Appl. No.: 10/676,284

(22) Filed: Oct. 1, 2003

Related U.S. Application Data
(63) Continuation-in-part of application No. 09/895,483, filed on Jun. 30, 2001.
(60) Provisional application No. 60/215,661, filed on Jul. 1, 2000.

(51) Int. Cl. G06F 17/60

(52) U.S. Cl. 705/37

(57) ABSTRACT

A method for conducting an auction in which bidders are encouraged to make more aggressive bids than they might otherwise make because they know that such bids will result in an ancillary advantage to themselves. The auction variables are those aspects of the auction that become the contract terms of the contract. In accordance with the illustrative embodiment, a relationship between a first auction variable and a second auction variable is defined and published, and the relationship is such that changes in the first auction variable in a direction favorable to the auction solicitor result in changes in the second auction variable in a direction favorable to bidders. This positive feedback mechanism encourages bidders to make more aggressive bids than they might otherwise make.

### REFERENCE TO RELATED APPLICATIONS

This application is a continuation-in-part of U.S. application Ser. No. 09/895,483, filed Jun. 30, 2001, now pending, which is itself based on U.S. application No. 60/215,661, filed Jul. 1, 2000, now expired. Both of these applications are incorporated herein by reference. The following patent applications are incorporated by reference:

1. U.S. patent application Ser. No. 09/896,715, filed on Jun. 30, 2001 and entitled “Formula-Based Computerized Auction” (Attorney Docket: 620-011us);

2. U.S. patent application Ser. No. 10/392,691, filed on Mar. 20, 2003 and entitled “Sealed-Bid Auction Comprising Staged Bid Publication” (Attorney Docket: 620-023us);

3. U.S. patent application Ser. No. 09/896,619, filed on Jun. 30, 2001 and entitled “System And Method For Computerized Auctions Having One Or More Rounds Of Bidding” (Attorney Docket: 620-014us);

4. U.S. patent application Ser. No. 10/058,145, filed Jan. 26, 2002, entitled “Multi-Tier Auction,” (Attorney Docket: 620-027us”);

5. U.S. patent application Ser. No. 09/935,812, filed Aug. 23, 2001, entitled “Construction Quote System,” (Attorney Docket: 620-018us”); and

6. U.S. patent application Ser. No. 09/938,141, filed Aug. 23, 2001, entitled “A Data Processing System that Provides an Auction with Programmable Proxy Bids,” (Attorney Docket: 620-020us”).

### FIELD OF THE INVENTION

The present invention relates to electronic commerce in general, and more particularly, to a data processing system-based auction method.

### BACKGROUND OF THE INVENTION

Auctions have existed since ancient times. In recent years, many data processing system-based auction systems and services have been developed (e.g. eBay, CommerceOne, SupplierMarket, SupplierOne, MaterialNet, etc.). Both traditional and data processing system-based auctions are often very effective in driving prices down (for reverse auctions) or driving prices up (for forward auctions) due to the competitive pressure of multiple bidders bidding on the same item.

One-on-one business negotiation is, if anything, even older than the auction. In common with the auction, the one-on-one negotiation has as its object the formation of an agreement to exchange one set of goods, money, or services for another set of goods, money, or services, either at the present time or at some future time. Agreements resulting from successful negotiations and agreements resulting from the acceptance of winning bids by auction solicitors can both be viewed as contracts. The contract is a familiar and well-studied subject in both business and law. One typical feature of contracts is that they may have multiple contract terms that represent multiple points of agreement between the parties on the things (goods, money, or services) to be exchanged and their characteristics or qualities.

While an auction and a one-on-one negotiation are in some ways similar, and while both, if successful, result in a contract, there are some differences. The one-on-one negotiation format represents a kind of maximum of flexibility in the business discussion between the parties. In the common phrase, it is possible to “put everything on the table,” meaning that potentially all terms of the contract under negotiation are up for discussion. This makes it relatively straightforward to propose tradeoffs, in which one party agrees to vary a certain contract term in exchange for some flexibility by the other party on another contract term. The ability to make these kinds of tradeoffs increases the possibility of agreement and also serves the interests of economic efficiency.

On the other hand, since a pure one-on-one negotiation involves only two parties, the competitive, price-driving nature of the auction format is lacking. This may mean that a seller in a one-on-one negotiation may get less for his goods or services than if that seller had been able to use an auction format to handle the sale. Analogously, a buyer in a one-on-one negotiation may pay more for his goods or services than if that buyer had been able to use an auction format to handle the purchase.

And, while auctions are generally effective at driving prices to levels advantageous to auction solicitors, they are not so good at supporting the kinds of tradeoffs on multiple terms which, in more flexible business negotiation formats, help promote the possibility of agreement and lead to increased economic efficiency. In particular, auctions are characterized by having a carefully-defined scope. The careful definition of auction scope is necessary so that bidders know exactly what they are bidding on, and so that bids can be fairly compared with one another. If the auction solicitor were allowed to vary the scope in response to specific bids or bidders, this would compromise the integrity of the bidding process.

The need exists, therefore, for more advantageous kinds of auctions.

### SUMMARY OF THE INVENTION

The present invention is a method for conducting an auction that provides a mechanism capable of encouraging more aggressive bidding in auctions. In particular, the illustrative embodiment provides an auction in which bidders are encouraged to make more aggressive bids than they might otherwise make because they know that such bids will result in an ancillary advantage to themselves.

In the law of contracts, an auction is considered as a process of contract formation, which culminates in a contract at the moment when a winning bid, constituting an offer, is accepted by the auction solicitor. For the purpose of this specification, the auction variables are those aspects of the auction that become the contract terms of the contract.

In the illustrative embodiment, a relationship between a first auction variable and a second auction variable is defined and published to all of the prospective bidders. Advantageously, the relationship is such that changes in the first auction variable in a direction favorable to the auction solicitor result in changes in the second auction variable in a direction favorable to bidders. In this way, the present invention is capable of encouraging more aggressive bids on the part of bidders than they might otherwise make.

In some embodiments, the auction may have multiple bid variables, and the winning bid is a resultant bid found by applying a bid formula to the multiple bid variables. In some embodiments, the data processing system may define and publish multiple relationships among auction variables, each of which may define one auction variable as a function or relation of multiple other auction variables.

The illustrative embodiment comprises: conducting an auction in behalf of an auction solicitor, by publishing from a data processing system a relationship between a first variable and a second variable, and selecting at the data processing system a winning bid, wherein the selection of the winning bid is dependent on the first variable.

### BRIEF DESCRIPTI N F THE DRAWINGS

FIG. 1 depicts a schematic diagram of the illustrative embodiment of the present invention.

FIG. 2 depicts a block diagram of a data processing system in accordance with the illustrative embodiment of the present invention.

FIG. 3 depicts a flowchart of the operation of the illustrative embodiment of the present invention.

FIG. 4 depicts a flowchart of the tasks associated with defining an auction as depicted in FIG. 3.

FIG. 5 depicts a flowchart of the tasks associated with conducting an auction as depicted in FIG. 3.

FIG. 6 depicts a flowchart of the tasks associated with the bidding and resolution phases of conducting an auction as depicted in FIG. 5.

FIG. 7 depicts examples of relationships which may be defined between a first auction variable and a second auction variable.

FIG. 8 depicts the relationships between first auction variables and second auction variables for three illustrative examples of the illustrative embodiment.

### DETAILED DESCRIPTION

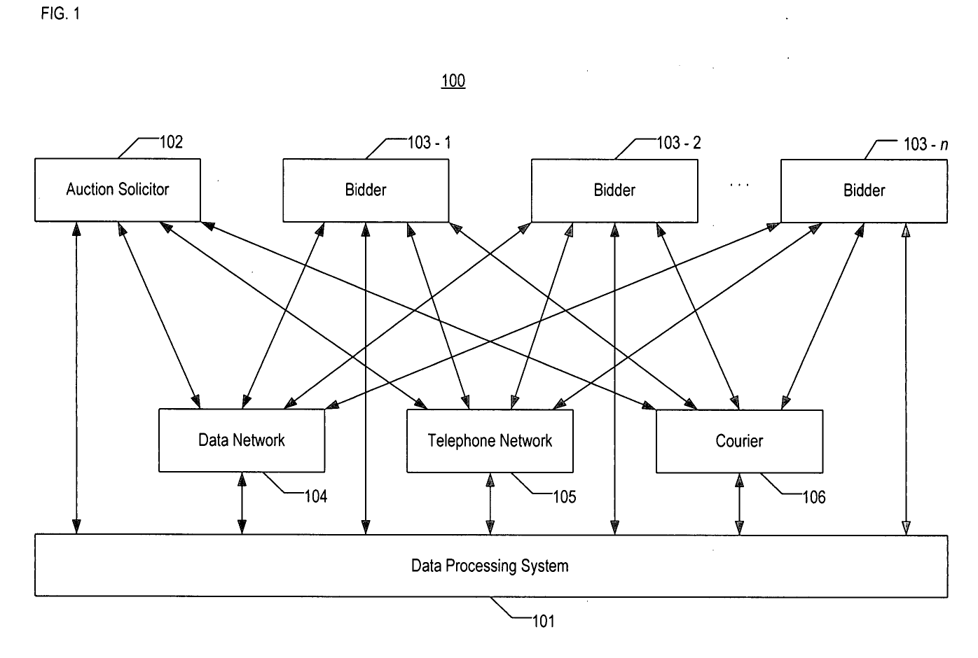

FIG. 1 depicts a schematic diagram of the illustrative embodiment of the present invention in which data processing system 101 conducts an auction (i.e., is the auctioneer of an auction) in behalf of auction solicitor 102 and between bidders 103-1 through 103-n, wherein n is a positive integer greater than zero. Data processing system 101 conducts the auction “in behalf” of the auction solicitor 102, rather than “on behalf” of the auction solicitor 102, because data processing system 101 and auction solicitor 102 can have, but do not necessarily have, an agent-principal relationship.

In accordance with the illustrative embodiment, data processing system 101 is owned and operated by one or more entities that are independent of auction solicitor 102 and bidders 103-1 through 103-n. In some alternative embodiments of the present invention, however, data processing system 101 is:

i. owned, or

ii. operated, or

iii. owned and operated,

by

i. auction solicitor 102, or

ii. one or more of bidders 103-1 through 103-n, or

iii. both auction solicitor 102 and one or more of bidders 103-1 through 103-n.

In accordance with the illustrative embodiment, the owner or the operator or the owner and the operator of data processing system 101 receives a fee in consideration for conducting an auction in behalf of auction solicitor 102. In some embodiments of the present invention, the fee is paid by auction solicitor 102. In some alternative embodiments of the present invention, the fee is paid by one or more of bidders 103-1 through 103-n.

In accordance with the illustrative embodiment, auction solicitor 102 and bidders 103-1 through 103-n are capable of providing data to and receiving data from data processing system 101 via:

i. data network 104 (e.g., the Internet, a private data network, a local area network, a wireless data network, etc.), or

ii. telephone network 105 (e.g., the Public Switched Telephone Network, a wireless telephony network, etc.), or

iii. courier 106 (e.g., Federal Express, the U.S. Mail, publication in a newspaper, publication in a periodical, etc.), or

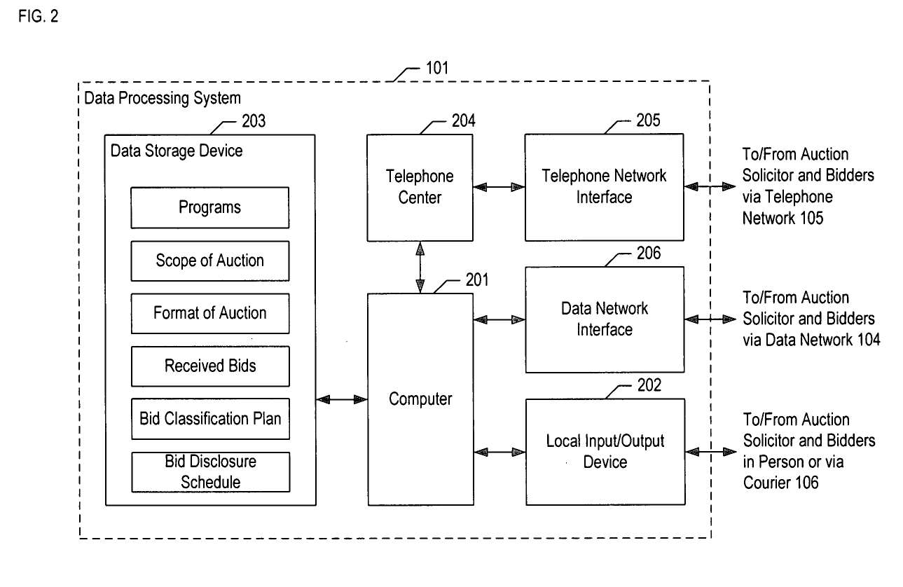

iv. in person by being co-located with local input/output device 202 (shown in FIG. 2) of data processing system 101, or

v. any combination of i, ii, iii, and iv.

It will be clear to those skilled in the art how to make and use embodiments of the present invention in which auction solicitor 102 and bidders 103-1 through 103-n communicate with data processing system 101 in person, through data network 104, telephone network 105, and/or courier 106.

FIG. 2 depicts a block diagram of the salient components of data processing system 101, which comprises computer 201, local input/output device 202, data storage device 203, telephone center 204, telephone network interface 205, and data network interface 206.

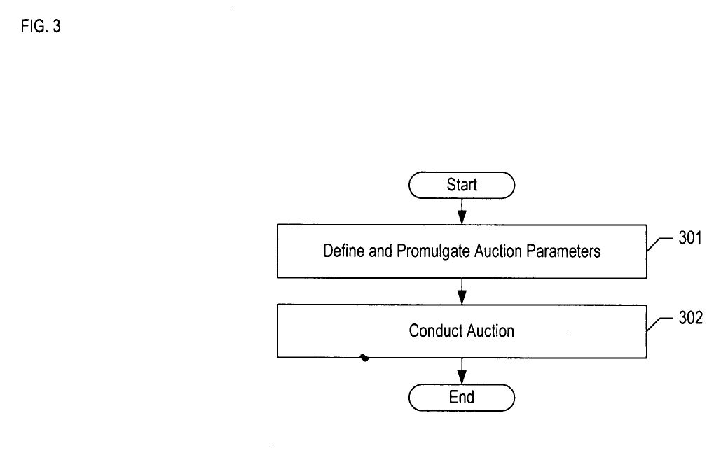

Computer 201 is a general-purpose processor that is capable of performing the functionality described below and with respect to FIGS. 3 through 5. For example, computer 201 is capable of:

executing one or more programs that are stored in data storage device 203;

storing data in and retrieving data from data storage device 203;

receiving data from and outputting data to local input/output device 202;

receiving data from and outputting data to telephone center 204; and

receiving data from and outputting data to data network interface 206.

Local input/output device 202 comprises one or more machines (e.g., terminals, scanners, printers, disk drives, displays, etc.) into which data from auction solicitor 102 and bidders 103-1 through 103-n can be received and from which data from data processing system 101 can be output to auction solicitor 102 and bidders 103-1 through 103-n.

Data storage device 203 is a non-volatile memory (e.g., a hard disk, flash memory, a tape drive, an optical device, etc.) for storing the programs executed by computer 201 and the data input into computer 201 and generated by computer 201.

Data network interface 206 enables auction solicitor 102 and bidders 103-1 through 103-n to communicate with data processing system 101 via a data network, such as the Internet. For example, data processing system 101 can receive data and can output data via Web pages.

Auction solicitor 102 and bidders 103-1 through 103-n can communicate with data processing system 101 via telephone, such as through a toll-free “800” number. To this end, telephone network interface 205 comprises one or more telephones that are capable of receiving calls from and placing calls to auction solicitor 102 and bidders 103-1 through 103-n. Telephone network interface 205 can further comprise an automatic call distribution system, in well-known fashion, for routing incoming calls to the various telephones. Furthermore, telephone network interface 205 is capable of receiving information from auction solicitor 102 and bidders 103-1 through 103-n via a touch-tone interface wherein the parties input information to the system by pushing the buttons on their telephones in response to questions from an automated operator.

Telephone center 204 comprises one or more computer terminals that are operated by the personnel associated with telephone network interface 205 such that an operator (either human or automated) can shuttle data between computer 201 and a bidder and auction solicitor 102, who is in contact with data processing system 101 via telephone network interface 205.

It will be clear to those skilled in the art how to make and use computer 201, local input/output device 202, data storage device 203, telephone center 204, telephone network interface 205, and data network interface 206.

Although data processing system 101 in FIG. 2 is shown as depicting only one computer, one local input/output device, one data storage device, one telephone center, one telephone network interface, and one data network interface, it will be clear to those skilled in the art that a data processing system in accordance with the present invention can comprise:

i. one or more computers, or

ii. one or more local input/output devices, or

iii. one or more data storage devices, or

iv. one or more telephone centers, or

v. one or more telephone network interface, or

vi. one or more data network interfaces, or

vii. any combination of i, ii, iii, iv, v, vi, and vii.

whether any combination of computers, local input/output devices, data storage devices, telephone centers, telephone network interfaces, and data network interfaces are networked (e.g., a wide area network, a local area network, etc.) or not networked (e.g., a sneakernet, etc.), that cooperate to perform the functionality described below and with respect to FIGS. 3 through 5. Furthermore, it will be clear to those skilled in the art that the various components of data processing system 101 need not be co-located, but can separated by hundreds or thousands of miles and networked (e.g., a wide area network, etc.) or not networked (e.g., a sneakernet, etc.).

FIG. 3 depicts a flowchart of the operation of the illustrative embodiment. For pedagogical purposes, the illustrative embodiment will be described in general and then it will be described in conjunction with illustrative examples. In accordance with this specification, the operation of the illustrative embodiment is described in terms of tasks and subtasks rather than steps because, as will be clear to those skilled in the art, some of the described tasks and subtasks can be performed in a single step. Furthermore, the illustrative embodiment is more easily understood when it is described in terms of its constituent tasks and subtasks that if it were described rigidly in terms of steps.

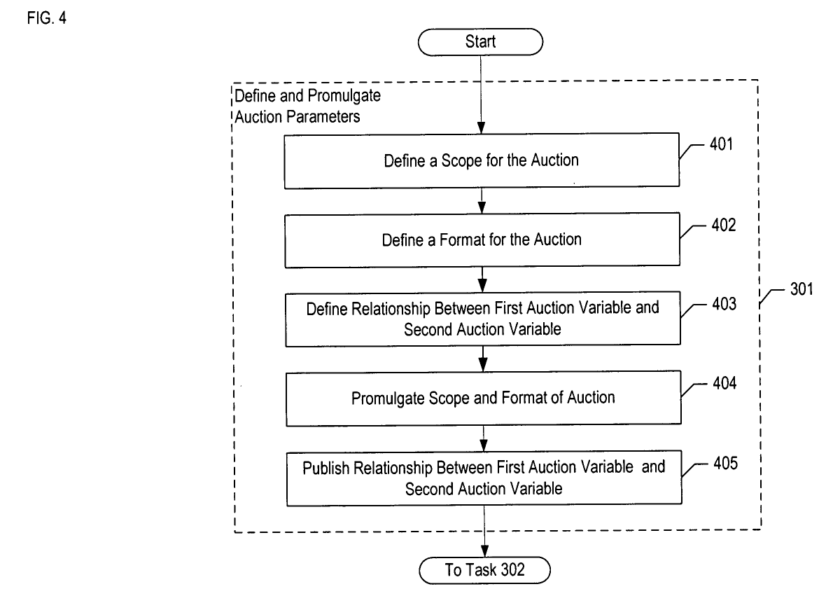

At task 301, the parameters of an auction are defined and promulgated. Although the auction solicitor typically initiates the need for the auction, and, therefore, defines the auction parameters, the auction solicitor might be assisted by consultants in the task of defining the auction parameters. In some alternative embodiments of the present invention, the operator of data processing system 101 can define some or all of the auction parameters. The details of task 301 are described below and with respect to FIG. 4 and its progeny.

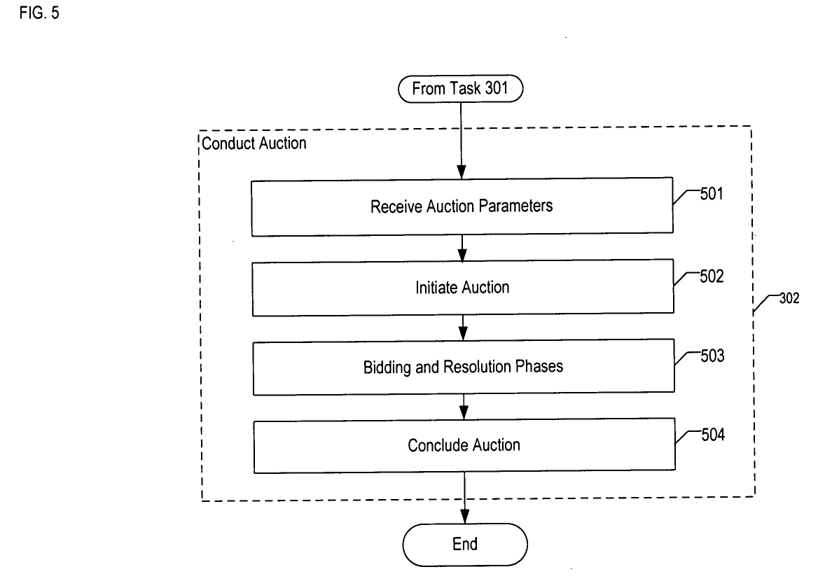

At task 302, the auction is conducted in accordance with the auction parameters that were defined and promulgated in task 301. The details of task 302 are described below and with respect to FIG. 5.

FIG. 4 depicts a flowchart of the subtasks that comprise task 301.

At subtask 401, a scope for an auction is defined. For the purposes of this specification, the “scope” of an auction is defined as what the auction solicitor seeks to provide (e.g., information, money, services, goods, reality, intangible property, intellectual property, etc.) in consideration for what the auction solicitor seeks to acquire (e.g., information, money, services, goods, realty, intangible property, intellectual property, etc.) as a result of the auction.

For example, when an auction solicitor is a cinder block manufacturer who seeks to sell one lot of 5,000 cinder blocks to one of several masons, the scope of the auction might be to provide 5,000 cinder blocks in consideration for an amount of money to be determined as part of the auction. As another example, when the auction solicitor is a taxi and limousine company that seeks a 1-year service contract for its fleet, the scope of the auction might reasonably be to acquire 48 oil changes for the vehicles in its fleet in a 12-month interval in consideration for a number of taxi rides to be determined as part of the auction and an amount of money to be determined as part of the auction.

The scope of the auction can, but does not necessarily, define the mandatory and non-discretionary aspects of a qualified bid, when any have been indicated by auction solicitor 102 or data processing system 101. In other words, a bid that does not satisfy all of the mandatory and non-discretionary requirements that are indicated is void or voidable at the auction solicitor's election. For example, for the taxi and limousine company that seeks the oil changes for its fleet, the mandatory and non-discretionary aspects of the scope of the auction might be that the winning bidder must supply at least five quarts of 10W-40 Mobil® One® oil and one Framm® oil filter in each of the 48 specified oil changes.

The scope of the auction can, but does not necessarily, define the optional or discretionary aspects of a qualified bid. The optional or discretionary aspects of a qualified bid are not essential elements that a bid must possess in order to be a qualified bid, but are variable factors that affect how the various bids are ranked and the winning bid(s) determined. For example, for the taxi and limousine company that seeks the oil changes for its fleet, there are two discretionary aspects of a qualified bid: (1) the number of taxi rides to be provided by the taxi and limousine company to the winning bidder, and (2) the amount of money to be provided by the taxi and limousine company to the winning bidder. In other words, because the taxi and limousine company seeks to pay for the oil changes with a combination of money and services, each bid will comprise:

1. an indicium of the number of taxi rides, and

2. an indicium of the amount of money

that in combination the bidder is willing to accept in consideration for the oil changes. For example, this enables a first bidder to indicate that it is willing to accept 100 taxi rides and no money in exchange for the oil changes, a second bidder to indicate that it is willing to accept 25 taxi rides and $400 in exchange for the oil changes, and a third bidder to indicate that it is willing to accept no taxi rides and $825 in exchange for the oil changes.

The mandatory and non-discretionary aspects of a bid and the optional or discretionary aspects of a bid can involve the same aspect. For example, when an auction solicitor desires to buy a truck, the scope of an auction might specify that a mandatory and non-discretionary aspect of the bid is a two-year warranty and an optional or discretionary aspect of the bid is a warranty for more than two years. In other words, the length of a warranty can be both a mandatory and non-discretionary aspect of the bid and an optional or discretionary aspect of the bid so long as there is some demarcation of the line between the mandatory and non-discretionary aspect and the optional or discretionary aspect.

The scope of the auction can, but does not necessarily, define the mandatory and non-discretionary requirements of a qualified bidder, when any have been indicated by auction solicitor 102 or data processing system 101. In other words, a bid from a bidder who does not satisfy all of the mandatory and non-discretionary requirements that are indicated is void or voidable at the auction solicitor's election. For example, when an auction solicitor is a corporation that seeks to provide dental care for its employees, the mandatory and non-discretionary aspects of the scope of the auction might reasonably be that the bidder, to be a qualified bidder, must hold a current and valid license to practice dentistry.

The scope of the auction can, but does not necessarily, define the optional or discretionary aspects of a qualified bidder. The optional or discretionary aspects of a qualified bidder are not essential elements that a bidder must possess in order to be a qualified bidder, but are factors that affect how the bid from the bidder is compared to other bids and how winning bid(s) are determined. Typically, the optional or discretionary aspects of a qualified bidder are framed in terms of a property of the bidder (e.g., how long the bidder has been in business, whether the bidder and the auction solicitor have ever done business before, the bidder's liquidity, etc.). For example, because the taxi and limousine company seeks to enter into a long-term contract, the company might reasonably place a premium in contracting with a bidder who is financially stable and who has been in business for a while. In this case, the scope of the auction might reasonably include as optional or discretionary aspects of the bid: (1) an indicium of the financial stability of the bidder, and (2) an indicium of the length of time that the bidder has been in business.

The mandatory and non-discretionary aspects of a bidder and the optional or discretionary aspects of a bidder can involve the same aspect. For example, when an auction solicitor desires to buy a truck, the scope of an auction might specify that a mandatory and non-discretionary aspect of the bidder is that the bidder has been in business for at least two years and an optional or discretionary aspect of the bidder is how long it has been in business for more than two years. In other words, the length of time that the bidder has been in business can be both a mandatory and non-discretionary aspect of the bidder and an optional or discretionary aspect of the bidder so long as there is some demarcation of the line between the mandatory and non-discretionary aspect and the optional or discretionary aspect.

In summary, the scope of the auction informs a candidate bidder with a complete and precise definition of:

i. what the auction solicitor seeks to acquire as a result of the auction,

ii. what the auction solicitor seeks to provide as a result of the auction,

iii. the mandatory and non-discretionary requirements of a qualified bid,

iv. the optional or discretionary aspects of a qualified bid,

v. the mandatory and non-discretionary requirements of a qualified bidder, and

vi. the optional or discretionary aspects of a qualified bidder.

In accordance with the illustrative embodiment, each bid comprises two or more optional or discretionary aspects that in combination determine the ordinal ranking of the bid with respect to the other bids. As described below, the illustrative embodiment comprises a mechanism for enabling the objective comparison and ordinal ranking of bids that comprise two or more optional or discretionary aspects of the bid or bidder or bid and bidder.

At subtask 402, the format of the auction is established. For example, the format of an auction specifies, but is not limited to:

i. when or under what circumstances the auction begins and ends,

ii. whether the bids are sealed or not,

iii. how many units or lots of the scope will be competed for,

iv. whether the auction occurs in one or more rounds,

v. how bids are made,

vi. how bids are evaluated and compared,

vii. the range of permissible bid amounts,

viii. the bid classification plan,

ix. the bid publishing schedule, and

x. how the winning bid(s) is determined.

For example, the illustrative embodiment can be used with, for example, one-sided auctions (e.g., the English auction format, the Dutch auction format, the Vickery auction format, the first-price, sealed-bid auction format, and their variants, etc.) and double-sided auctions (e.g., the continuous double auction format, the Double Dutch auction format, the Japanese auction format, and their variants, etc.).

In accordance with the illustrative embodiment, the bids are compared and ranked by plugging in the value of the optional or discretionary aspects associated with each bid into a formula to produce a resultant bid and then by ranking the resultant bids based on their relative magnitude.

In accordance with the illustrative embodiment, data processing system 101 receives T bids in an auction, wherein T is a positive integer greater than zero. In accordance with the illustrative embodiment, each bid, bₖ, wherein k=1 to T, comprises m bid variables, v_{1,k} through v_{m,k}. For the purposes of this specification, a “bid variable” is defined as a discretionary or optional aspect of a bid. The integrity of the auction process is enhanced when the bid variables are defined in such a way that their values can be determined or verified objectively and not subjectively.

A bid variable can be, for example:

a binary bid variable (e.g., the inclusion or absence of a warranty in a bid, whether the bidder has or has not previously supplied similar scope to the auction solicitor in the past, whether the bidder has small disadvantaged business status, etc.); or

an integer bid variable (e.g., the number of workers to be assigned to a project, the number of computers to be tendered, etc.); or

a continuous bid variable (e.g., the fuel mileage of a dump truck, the length of time that a warranty will run, etc.).

A binary bid variable has two possible values, TRUE or FALSE. An integer bid variable and a continuous bid variable can have no bounds (i.e., range from negative infinite to positive infinite), or can have a single bound (i.e., v₃>34), or can have two bounds (i.e., 34<v₃<57), or more than two bounds (i.e., 34<v₃<57 or v₃>135).

A bid variable can be a dimensioned or dimensionless quantity. Example dimensioned bid variables that relate to physical properties include, but are not limited to:

i. mass (e.g., the mass of a projectile, etc.);

ii. weight (i.e., force) (e.g., the weight of a portable computer, etc.);

iii. length (e.g., the length of an I-beam, the distance of the bidder's premises to the job site, the perimeter of a field, etc.);

iv. area (e.g., the area of a rug, etc.);

v. volume (e.g., the volume of a refrigerator, etc.);

vi. time (e.g., the length of time that a warranty will run, the number of years of experience that the bidder has in some field, when the bidder demands to be paid, etc.);

vii. electrical charge (e.g., the maximum number of coulombs held in a capacitor, etc.);

viii. energy (e.g., the storage capacity of a battery, etc.);

ix. power (e.g., the horsepower of an engine, etc.);

x. pressure (e.g., the average pressure created by a pump, etc.)

xi. velocity (e.g., the maximum speed of an aircraft, etc.);

xii. acceleration (e.g., the effectiveness of a parachute, etc.);

xiii. acidity (e.g., the pH of a dye, etc.);

xiv. a performance metric (e.g., the effectiveness of a drug in obtaining results, etc.); and

xv. any combination of i, ii, iii, iv, v, vi, vii, viii, ix, x, xi, xii, xiii, and xiv.

Example dimensioned bid variables that relate to finance include, but are not limited to:

i. money (e.g., the price for a hundred gallons of orange-juice, etc.);

ii. interest (e.g., the rate at which past due invoices will be charged interest, etc.);

iii. liquidity (e.g., the cash-to-asset ratio of the bidder, etc.); and

iv. financial stability (e.g., the credit rating of the bidder, etc.);

Example dimensioned bid variables that relate to a property of the bidder itself include, but are not limited to:

i. a satisfaction metric (e.g., how pleased other parties have been with the past performance of the bidder as measured a by survey, etc.);

ii. a performance metric (e.g., the effectiveness of a bidder in obtaining results, etc.);

iii. a financial stability metric (e.g., the credit rating of the bidder, etc.);

iv. a delivery history metric (e.g., the percentage of packages delivered by the bidder on time, etc.); and

v. a service metric (e.g., how often the bidder successfully completes repairs in only one service call, etc.).

It will be clear to those skilled in the art how to define and utilize other bid variables in embodiments of the present invention. Furthermore, it will be clear to those skilled in the art that the degree of discretion that a bidder has to affect the value of a particular bid variable can range from no discretion to absolute discretion.

When data processing system 101 receives a bid, it produces a resultant bid, rₖ, for the bid, bₖ. In some alternative embodiments of the present invention, a bidder can submit the resultant bid, rₖ, with the m bid variables, v₁ through vₘ, as part of the bid. In these embodiments, data processing system 101 reproduces the resultant bid, rₖ, using its own parameters to verify the value of the resultant bid submitted.

In any case, the resultant bid, rₖ, is determined from the m bid variables, v_{1,k} through V_{m,k}, and c bid weights, w₁ through w_{c}. For the purposes of this specification, a “bid formula” is defined as the manner in which a plurality of bid variables are combined to produce a resultant bid. The general expression of the bid formula is depicted in Equation 1.

rₖ=f(v_{1,k},v_{2,k} , . . . v_{m,k}, w₁,w₂, . . . w_{c}) (Eq. 1)

In accordance with the illustrative embodiment, the resultant bid, rₖ, is dimensioned in “equivalent dollars” for ease of description, which indicates that each of the c bid weights, w₁ through w_{c}, is dimensioned in units that when combined with the m bid variables, v_{1,k} through v_{m,k}, produce an output dimensioned in equivalent dollars. In some alternative embodiments of the present invention, the resultant bid, rₖ, is dimensioned in another dimension or is a dimensionless quantity.

In accordance with the illustrative embodiment, each of the c bid weights is a constant. In some alternative embodiments of the present invention, one or more of the c bid weights is a function of one or more of the bid variables (e.g., w₃=f(v₃), w₄=f(v₃, V₄), etc.). The function can be continuous (i.e., the derivative is defined over the range of interest) or discontinuous (i.e., the derivative is not defined everywhere within the range of interest).

Furthermore, in accordance with the illustrative embodiment, the signs of the c bid weights are chosen so that positive attributes of a bid (e.g., the fuel efficiency of an engine, etc.) have a different polarity than negative attributes of a bid (e.g., the amount of pollution created by an engine, etc.) to enable bid variables that indicate positive attributes of a bid to offset bid variables that indicate negative attributes of the bid. In any case it will be clear to those skilled in the art how to choose the respective values of the c bid weights, w₁ through w_{c}.

In accordance with the illustrative embodiment, the magnitude of the resultant bid, rₖ, is a linear function of the value of each of the m bid variables, v_{1,k} through v_{m,k}, as depicted in Equation 2.

$${r}_{k} = {\sum }_{j = 1}^{m} {w}_{j} {v}_{j , k} = {w}_{1} {v}_{1 , k} + {w}_{2} {v}_{2 , k} + ⋯ + {w}_{m} {v}_{m , k} \qquad ( Eq . 2 )$$

It will be clear to those skilled in the art how to make and use other bid formulas for use with other embodiments of the present invention. For example, it will be clear to those skilled in the art how to define a bid formula in which the magnitude of the resultant bid, rₖ, is a nonlinear function of the value of at least one of the m bid variables, v_{1,k} through v_{m,k}. For example, Equation 3 depicts an example of a bid formula in which the value of the resultant bid, rₖ, is a function of 2 bid variables, v_{1,k} and v_{2,k}, and 6 bid weights w₁ through w₆.

rₖ=w₁v_{1,k}³+w₂v_{1,k}²+w₃e^{r}^{_{1,k}}+w₄v_{1,k}v_{2,k}+w₅ sin(w₆v_{2,k}) (Eq. 3)

When the resultant bid, rₖ, for two or more bids are computed, the resultant bids are ranked based on their relative magnitude. When the auction has concluded, the bid associated with the resultant bid whose magnitude is most advantageous to the auction solicitor is declared the winning bid.

It should be understood that each bid comprises multiple bid variables not merely to break a tie between two bids that have the same value for one bid variable, but so that bids that have no ties in any one bid variable can be compared and ranked. That is not to say that two bids in accordance with the present invention cannot have the same value for a bid variable, but that the values of all of the bid variables affect the outcome of an auction. In some alternative embodiments of the present invention, however, no two bids have the same value for any one bid variable (i.e., v_{q,1} does not equal v_{q,2}, for q=1 to m) in one auction.

The preceding discussion was focused on “bid variables,” with bid variable defined to be “a discretionary or optional aspect of a bid.” The more general term “auction variable” will now be introduced.

In the law of contracts, an auction is considered as a process of contract formation, which culminates in a contract at the moment when a winning bid, constituting an offer, is accepted by the auction solicitor. For the purpose of this specification, the auction variables are those aspects of the auction that become the contract terms of the contract. The bid variables of an auction are a subset of the auction variables.

In the present invention, mathematical relations are defined which establish rules of correspondence between the values of at least one auction variable and at least one other auction variable. While in the present invention these relations can be quite general, for simplicity of exposition further discussion will focus on the well-known type of relation called a function, which is a single-valued relation. That is, if the function is written in equation form as y=f(x), meaning “y is a function, f, of x” then for every value of the independent variable, x, there is just one value of the dependent variable, y. It is permissible, of course, for a function to define a dependent variable as a function of multiple independent variables, for example y=f(x₁, x₂, . . . xₙ).

When there are only two or three variables (a dependent variable and one or two independent variables), the relationship described by the function can conveniently be shown in graphical form.

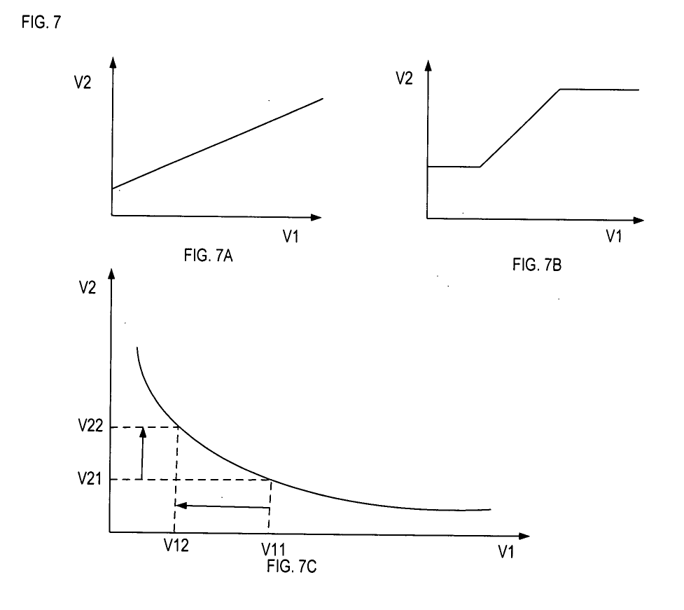

FIG. 7 presents examples for cases involving only two auction variables, represented as two-dimensional plots. In each of the sub-figures of FIG. 7, V1 represents a first auction variable and V2 represents a second auction variable.

FIG. 7A shows an example wherein V2 is a linear function of V1.

FIG. 7B shows an example wherein V2 is a piecewise linear function of V1.

FIG. 7C shows an example wherein V2 is a nonlinear function of V1. FIG. 7C further illustrates a feature of some embodiments of the present invention, wherein the particular relationship between V2 and V1 is such that a change in the value of V1 in a direction favorable to the auction solicitor will cause a change in the value of V2 in a direction favorable to a bidder. Specifically, in this example, it is the case that decreases in V1 are favorable to the auction solicitor and that increases in V2 are favorable to a bidder. The relationship (in this case, a nonlinear relationship with a generally negative slope) determines by how much the value of V2 will increase when V1 decreases from one specific value to a different specific value. Thus, here, when V1 decreases from the value V11 to the value V12, V2 increases from the value V21 to the value V22, or by an amount (V22-V21).

In some embodiments of the present invention, relationships between two auction variables such as those illustrated here may be advantageously used to encourage a bidder to present bids more favorable to the auction solicitor in one auction variable because presenting more favorable bids in one auction variable results in a favorable change in a second auction variable of interest to the bidder. Note that, in such embodiments, it will often be the case that the first auction variable will be a bid variable and the second auction variable will be an auction variable which is not a bid variable, but instead is some other auction variable whose value can influence the bidding behavior of bidders, and typically is some item in the auction scope which is a thing provided by or done by the auction solicitor.

Many possible pairs of such auction variables may be identified. Some examples are shown in the following table:

TABLE 1
Example Relationships between Auction Variables

| FIRST AUCTION VARIABLE | SECOND AUCTION VARIABLE |
|---|---|
| Delivery schedule | Price |
| Time to complete | Price |
| Measure of quality | Price |
| Price | Warranty period |
| Price | Service contract price |
| Price | Service contract length |
| Price | Service contract scope |
| Price | Provision of one or more articles |
| | free of charge |
| Quantity | Price |

While the above table and FIG. 7, for simplicity of illustration, show only pairs of auction variables, it will be understood that in general a given auction variable can be defined as a function of multiple other auction variables. And, since an auction variable can be a function of multiple other auction variables, this also embraces the important case where an auction variable is a function of a resultant bid, which in turn is a function of the bid variables. That is, if

rₖ=f(v_{1,k}, v_{2,k}, . . . v_{m,k}, w₁,w₂, . . . , w_{c}),

where rₖ is the kth resultant bid, v_{1,k} through v_{m,k} are bid variables for the kth bid and w₁ through w_{c} are weights, and if

uₖ=g(rₖ),

where uₖ is the value at the kth bid of a particular auction variable then

uₖ=g(f(v_{1,k}, v_{2,k}, . . . v^{m,k}, w₁, w₂, . . . w_{c})),

and the composite function g(f( )) may be replaced by a function h( ), so that

uₖ=h(v_{1,k}, v_{2,k}, . . . , v_{m,k}, w₁, w₂, . . . , w_{c})

The importance of this is that the present invention is readily applicable (though of course not only applicable) to auctions in which there are multiple bid variables, with bids compared and winners chosen by means of a bid formula.

With continuing reference to FIG. 4, it will be seen at subtask 403 that, in the illustrative embodiment, a relationship is defined between the values of a first auction variable and the values of a second auction variable. As previously discussed, the relationship may be defined mathematically as a function or relation. Advantageously, the first auction variable is a bid variable and the second auction variable is one which is not a bid variable, but is an auction variable whose value can influence the bidding behavior of bidders.

With continuing reference to FIG. 4, it will be seen at subtask 404 that the scope of the auction and the format of the auction are promulgated to candidate bidders. This can be achieved, illustratively, via:

i. data network 104 (e.g., the Internet, a private data network, a local area network, a wireless data network, etc.), or

ii. telephone network 105 (e.g., the Public Switched Telephone Network, a wireless telephony network, etc.), or

iii. courier 106 (e.g., Federal Express, the U.S. Mail, publication in a newspaper, publication in a periodical, etc.), or

iv. in person by being co-located with local input/output device 202 (shown in FIG. 2) of data processing system 101, or

v. any combination of i, ii, iii, and iv.

At subtask 405 of the illustrative embodiment, the relationship between the first and second auction variables is published by the data processing system 101. The relationship is the one that was defined at subtask 403. The audience to whom the relationship is published comprises the bidders 103-1 to 103-n. Publication of the relationship can be achieved, illustratively, via:

i. data network 104 (e.g., the Internet, a private data network, a local area network, a wireless data network, etc.), or

ii. telephone network 105 (e.g., the Public Switched Telephone Network, a wireless telephony network, etc.), or

iii. courier 106 (e.g., Federal Express, the U.S. Mail, publication in a newspaper, publication in a periodical, etc.), or

iv. in person by being co-located with local input/output device 202 (shown in FIG. 2) of data processing system 101, or

v. any combination of i, ii, iii, and iv.

FIG. 5 depicts a flowchart of the subtasks that comprise task 302.

At subtask 501, the auction parameters (e.g., the scope of the auction, the format of the auction, the bid formula, etc.) are received by data processing system 101. This enables data processing system 101 to conduct the auction in accordance with the auction parameters.

At subtask 502, the auction is initiated. In accordance with the illustrative embodiment of the present invention, data processing system 101 signals the beginning of the auction. When the auction format includes multiple bidding rounds, data processing system 101 signals the beginning and ending of each round. In any case, it will be clear to those skilled in the art how to initiate the auction.

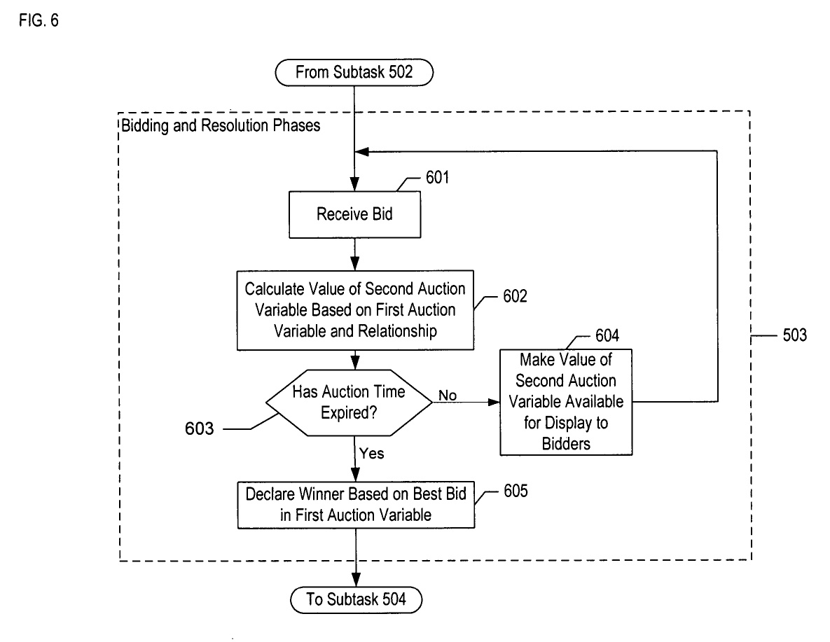

At subtask 503, the bidding and resolution phases of the auction are conducted. When the auction comprises multiple rounds, subtask 503 is performed once for each round. Subtask 503 is described in detail below and with respect to FIG. 6.

At subtask 504, the auction ends and data processing system 101 outputs an indicium of the winning bid (when the auction format specifies that there is one winning bid) or bids (when the auction format specifies that there is more than one winning bid) when the auction format indicates that the auction has ended. This information is distributed to auction solicitor 102 and bidders 103-1 through 103-n via:

i. data network 104 (e.g., the Internet, a private data network, a local area network, a wireless data network, etc.), or

ii. telephone network 105 (e.g., the Public Switched Telephone Network, a wireless telephony network, etc.), or

iii. courier 106 (e.g., Federal Express, the U.S. Mail, publication in a newspaper, publication in a periodical, etc.), or

iv. in person by being co-located with local input/output device 202 (shown in FIG. 2) of data processing system 101, or

v. any combination of i, ii, iii, and iv.

FIG. 6 depicts a flowchart of the salient subtasks that compose task 503, the bidding and resolution phases of the auction.

At subtask 601, the illustrative embodiment receives a bid package from a bidder. In the course of subtask 503, the illustrative embodiment receives T bid packages, bpₖ, wherein k=1 to T, wherein T is a positive integer greater than zero.

In accordance with the illustrative embodiment, the bid packages can be received by data processing system 101 concurrently or periodically or sporadically during the auction, as specified by the format of the auction.

In accordance with the illustrative embodiment, each bid package, bpₖ, is received by data processing system 101 via:

i. data network 104 (e.g., the Internet, a private data network, a local area network, a wireless data network, etc.), or

ii. telephone network 105 (e.g., the Public Switched Telephone Network, a wireless telephony network, etc.), or

iii. courier 106 (e.g., Federal Express, the U.S. Mail, publication in a newspaper, publication in a periodical, etc.), or

iv. in person by being co-located with local input/output device 202 (shown in FIG. 2) of data processing system 101, or

v. any combination of i, ii, iii, and iv.

In accordance with the illustrative embodiment, each bid package, bpₖ, comprises at least:

1. a direction to enter a bid, bₖ, into the auction;

2. a value for each of the m bid variables, v_{1,k} through v_{m,k}, associated with the bid;

3. one or more indicia that the bid satisfies the mandatory and non-discretionary aspects of a qualified bid; and

4. one or more indicia that the bidder satisfies the mandatory and non-discretionary aspects of a qualified bidder.

In accordance with the illustrative embodiment, the value of each of the m bid variables, v_{1,k} through v_{m,k}, is:

i. explicitly stated in the bid package; or

ii. implicitly stated in the bid package; or

iii. determined by data processing system 101 by reference to a default value; or

iv. determined by data processing system 101 by reference to public information; or v. determined by data processing system 101 by reference to private information; or

vi. determined in accordance with any combination of i, ii, iii, iv, and v.

For example, the first bid package from each bidder explicitly states a value for each of the m bid variables, v_{1,k} through v_{m,k}, that are not determined by default or incorporated by reference. Furthermore, subsequent bid packages only explicitly state a value for those bid variables whose value has changed from the last bid. In this case, the bid variables whose value has not changed from the previous bid can be reasonably deemed to be implicitly stated in the bid package.

The auction format might indicate a default value for one or more of the m bid variables, v_{1,k} through v_{m,k}, such that a bid package need not explicitly state a value for those bid variables unless the bidder desires to override the default value.

A bid package, bpₖ, might instruct data processing system 101 to determine the value of one or more of the m bid variables, v_{1,k} through v_{m,k}, by reference to public or private information. For example, data processing system 101 might be instructed to determine the value of a bid variable by reference to another bidder's bid (e.g., v_{k,1} equals v_{k-1,1} plus $50, etc.), other bid variables of bidder's bid, or the financial markets (e.g., v_{1,k} equals the S&P 500 index at 10:00 AM today minus 25.00, etc.).

From subtask 601, control passes to subtask 602. It will be recalled from the description of FIG. 4 that, in the illustrative embodiment of the present invention, the value of a second auction variable is determined by the value of a first auction variable and a relationship, as defined in subtask 403. Here, at subtask 602, data processing system 101 calculates the value of the second auction variable for this bid, bₖ, based on the value of the first auction variable for this bid, bₖ, and the relationship.

From subtask 602, control passes to subtask 603. In the illustrative embodiment of the present invention, bids can be received over a period of time until the time for the auction expires. Accordingly, subtask 603 provides a test that determines whether or not the time for the auction has expired. In alternative implementations, based, for example, on different auction formats, the notion of receiving bids over a period of time until the expiration of an auction time may not apply. For example, in some alternative embodiments, all bids may be due at the same time, or bids may be received until some predefined value of a variable is reached, etc.

If, at subtask 603, it is determined that the time for the auction has not expired, then control passes to subtask 604. At subtask 604, data processing system 101 makes the calculated value of the second variable available for display to the bidders. Illustratively, this may be accomplished by means of:

i. data network 104 (e.g., the Internet, a private data network, a local area network, a wireless data network, etc.), or

ii. telephone network 105 (e.g., the Public Switched Telephone Network, a wireless telephony network, etc.), or

iii. courier 106 (e.g., Federal Express, the U.S. Mail, publication in a newspaper, publication in a periodical, etc.), or

iv. in person by being co-located with local input/output device 202 (shown in FIG. 2) of data processing system 101, or

v. any combination of i, ii, iii, and iv.

From subtask 604, control passes back to subtask 601, i.e., data processing system 101 prepares to receive another bid.

If, at subtask 603 in the illustrative embodiment, the test determines that the auction time has expired, then control passes from subtask 603 to subtask 605. In alternative implementations, based, for example, on different auction formats, the notion of receiving bids over a period of time until the expiration of an auction time may not apply. For example, in some alternative embodiments, all bids may be due at the same time, or bids may be received until some predefined value of a variable is reached, etc.

At subtask 605, data processing system 101 determines and declares the winner based on the best bid. In the illustrative embodiment, data processing system 101 determines the winner based on the best bid in the first auction variable. In alternative embodiments, as discussed above, data processing system 101 may determine and declare the winner based on the best resultant bid based on multiple bid variables and a bid formula.

From subtask 605, control passes to subtask 504.

For pedagogical purposes, the illustrative embodiment will now be described in conjunction with illustrative examples.

### EXAMPLE 1

### Time of Delivery is Critical

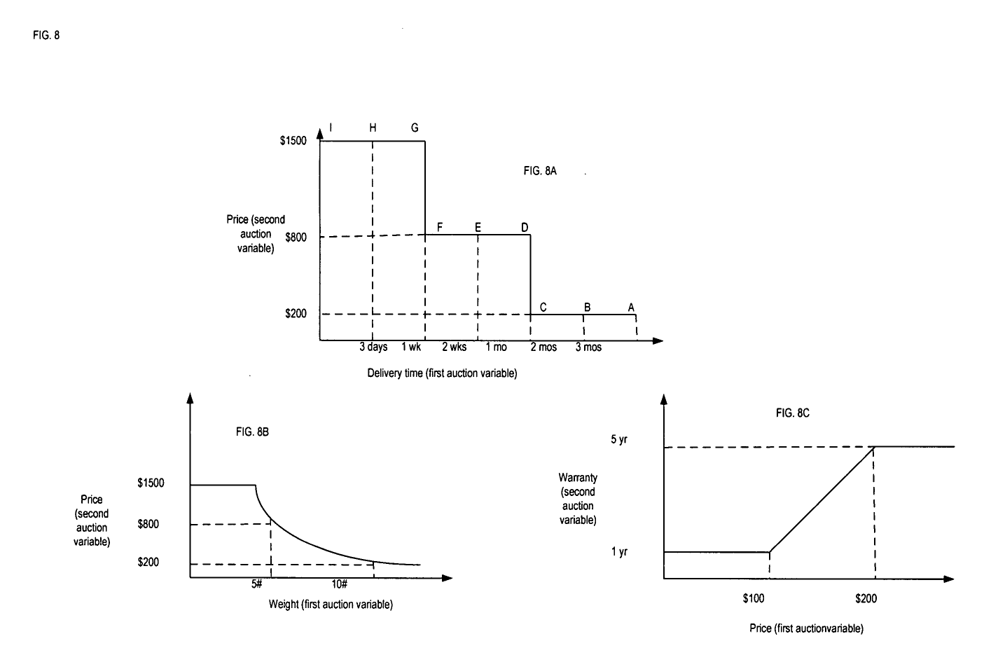

As an example, consider a reverse auction for a component to be used in a machine on an assembly line. See FIG. 8A. Normally, the market rate for this particular component is $200 and it usually takes a few months to acquire. Here, however, the component is required immediately to repair a failed machine, so delivery time is crucial and valuable. The buyer is willing to flex a second auction variable (price) in order to enhance offers in the first auction variable (time of delivery). Obtaining the component in under one week is extremely valuable, since production can continue uninterrupted. Obtaining the component in under a month would also be valuable, though somewhat less valuable than obtaining it in under a week since production would be halted temporarily. Obtaining the product in anything longer than a month is of little additional value, since this is the normal market delivery time.

The buyer sets up a multi-variable auction in which time of delivery is the first auction variable and price of the item is the second auction variable. In this case, the buyer utilizes a stepped relationship plot with steps at delivery times he feels represent quantum increases in value. A minimum bid is set at a 3 month delivery time.

The starting bid is 3 months. If the starting bid is awarded as the winning bid, the buyer will pay $200. This is represented as point A on FIG. 8A, where $200 and 3 months intersect.

Bids are then taken by the data processing system, and they traverse along the relationship plot graphically. The next bid at point B is for a 2 month manufacturing time. This is desirable to the buyer since it is better than 3 months, but according to the relationship plot, not yet desirable enough to increase the price he wishes to pay for the component. Bidding continues, and when the bids reach 1 month delivery time, the buyer is willing to increase his offer for the component to $800. This is due to the buyer's internal value of the component's worth if it can be delivered within 1 month, and is represented by the point D on the relationship plot.

As bids move from D to F, the pricing remains at $800 for the component. When a bidder makes an offer for 1 week delivery, the buyer will increase the purchase price to $1500, represented by the relationship plot line of G to I. This again, is due to internal valuation differences of the component.

The lowest bid is shown at point H. This bidder offered to deliver this product in 3 days, the best offer in the prime variable, and he will be paid $1500 for it based upon the relationship plot. He would not have bid such an aggressive delivery time for the conventional $200 fee for this part.

### EXAMPLE 2

### Weight is Critical

As a second example, consider an aircraft manufacturer seeking the supplier who can manufacture the lightest component. FIG. 8B depicts a relationship plot for such a data processing system-based auction where the first auction variable is weight and the second auction variable is price.

The proceedings of the auction are similar to the previous example. Bidders bid based upon the weight of the component they can provide. The buyer is willing to pay more for bids of lower weight. The primary difference in this example is the specific shape of the relationship plot.

In the example, the aircraft manufacturer places the same low value ($200) on any component that weighs 10 pounds or more, so the curve of the relationship plot flattens out for 10 pounds and greater weights. As the weight drops, the buyer's willingness to pay actually accelerates, so the curvature of the curve increases, incenting the bidders to achieve the lower weights. The buyer has also stipulated a top price he will pay for the component, $1500, by flattening the curve at that point.

### EXAMPLE 3

### Maximizing Price is Critical

A third example is shown in FIG. 8C. This shows a forward, English auction where the first auction variable is price and the second auction variable is warranty period. The seller in this case desires to maximize price, and is willing to increase the warranty on the product in search of a higher bid. In this example, the relationship plot is piecewise linear: flat up until $100, positively sloped between $100 and $200, then flat after that, showing that the seller does not wish to augment the warranty more than 5 years in this case.

As bidders increase their prices, they will be rewarded with increased warranty terms on the product as the market price is driven above $100, up to a maximum warranty term of 5 years.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A method of conducting an auction in behalf of an auction solicitor, said method comprising:
publishing from a data processing system a relationship between a first auction variable and a second auction variable; and
selecting at said data processing system a winning bid in said auction, wherein the selection of said winning bid is dependent on said first auction variable.

2. The method of claim 1 wherein said winning bid is independent of said second auction variable.

3. The method of claim 1 wherein said first auction variable is delivery schedule and said second auction variable is price.

4. The method of claim 1 wherein said first auction variable is time to complete and said second auction variable is price.

5. The method of claim 1 wherein said first auction variable is a measure of quality and said second auction variable is price.

6. The method of claim 1 wherein said first auction variable is price and said second auction variable is warranty period.

7. The method of claim 1 wherein said first auction variable is price and said second auction variable is service contract price.

8. The method of claim 1 wherein said first auction variable is price and said second auction variable is service contract scope.

9. The method of claim 1 wherein said first auction variable is price and said auction variable is the provision of one or more articles free of charge.

10. The method of claim 1 wherein the data processing system calculates the value of said second auction variable based on said first auction variable and said relationship for each bid as it is received, and makes available said value of said second auction variable for display to one or more bidders.

11. A method of conducting an auction in behalf of an auction solicitor, said method comprising:
publishing from a data processing system a relationship between a first auction variable and a second auction variable, wherein said relationship is such that a change in said first auction variable in a direction that is favorable to said auction solicitor induces a change in said second auction variable in a direction that is favorable to a bidder; and
selecting at said data processing system a winning bid in said auction based on said first auction variable.

12. The method of claim 11 wherein said first auction variable is delivery schedule and said second auction variable is price.

13. The method of claim 11 wherein said first auction variable is time to complete and said second auction variable is price.

14. The method of claim 11 wherein said first auction variable is a measure of quality and said second auction variable is price.

15. The method of claim 11 wherein said first auction variable is price and said second auction variable is warranty period.

16. The method of claim 11 wherein said first auction variable is price and said second auction variable is service contract price.

17. The method of claim 11 wherein said first auction variable is price and said second auction variable is service contract scope.

18. The method of claim 11 wherein said first auction variable is price and said auction variable is the provision of one or more articles free of charge.

19. The method of claim 11 wherein said first auction variable is quantity and said second auction variable is price.

20. The method of claim 11 wherein the data processing system calculates the value of said second auction variable based on said first auction variable and said relationship for each bid as it is received, and makes available said value of said second auction variable for display to one or more bidders.
